(19) United States
(12) Patent Application Publication
(10) Pub. No.: US 2026/0119841 A1
(43) Pub. Date: Apr. 30, 2026

(54) COMPUTATIONAL STORAGE DEVICE AND SYSTEM INCLUDING THE SAME

(71) Applicant: SAMSUNG ELECTRONICS CO., LTD., Suwon-si (KR)

(72) Inventors: Myoungsoo JUNG, Daejeon (KR); Seungkwan KANG, Daejeon (KR); Hyungseok KO, Daejeon (KR); Heemin KIM, Daejeon (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 19/305,170

(22) Filed: Aug. 20, 2025

(30) Foreign Application Priority Data
Oct. 28, 2024 (KR) 10-2024-0149076

(51) Int. Cl. G06N 3/0455

(52) U.S. Cl. CPC G06N 3/0455

(57) ABSTRACT

The present disclosure relates to a computational storage device including a memory array configured to store a corpus including a plurality of subsets, and a hardware accelerator configured to obtain a language model; read the plurality of subsets from the memory array; generate, based on the plurality of subsets, a tokenizer of the language model, and an embedding layer of the language model, a plurality of embedding vectors, the plurality of embedding vectors comprising a first embedding vector and a second embedding vector; write the plurality of embedding vectors in the memory array; read, from the memory array, at least one embedding vector associated with a user query from the plurality of embedding vectors; and perform an inference operation that outputs a response associated with the user query, based on the user query, the at least one embedding vector, and the language model.

### CROSS-REFERENCE TO RELATED APPLICATION

The present application claims priority to Korean Patent Application No. 10-2024-0149076, filed on October 28, 2024, the entire contents of which are incorporated herein for all purposes by this reference.

### BACKGROUND

### Field

The present disclosure relates to a computational storage device, specifically, a computational device that performs an inference operation using a language model and system including the same.

### Description of Related Art

A generative language model is an artificial intelligence (AI) technology that generates new texts based on input text data. The generative language model may be trained on a large amount of text data and may automatically generate texts that fit various topics or styles. The language model is mostly used in the field of natural language processing and in various application fields such as machine translation, text summarization, conversational AI, etc. The language model is also widely used to process complex language structures or unstructured data.

Data input into a language model may be processed in a multilayer network of the language model through an inference operation. Text responses in various forms may be generated through the inference operation of the language model.

### SUMMARY

The present disclosure is related to a computational storage device for accelerating an inference operation of a language model and a system including the same.

The problem to be solved is not limited to the above, but the other tasks not mentioned above may be explicitly known to those skilled in the art from the description of the present disclosure below.

According to embodiments, a computational storage device is provided, including a memory array configured to store a corpus including a plurality of subsets, the plurality of subsets including a first subset and a second subset, and a hardware accelerator configured to obtain a language model; read the plurality of subsets from the memory array; generate, based on the plurality of subsets, a tokenizer of the language model, and an embedding layer of the language model, a plurality of embedding vectors, the plurality of embedding vectors comprising a first embedding vector and a second embedding vector; write the plurality of embedding vectors in the memory array; read, from the memory array, at least one embedding vector associated with a user query from the plurality of embedding vectors; and perform an inference operation that outputs a response associated with the user query, based on the user query, the at least one embedding vector, and the language model.

According to embodiments, a computational storage system is provided, including a host processor and a host device including a host memory connected to the host processor, and a computational storage device configured to communicate with the host processor and generate an output. The computational storage system includes a memory array configured to store a corpus, the corpus comprising a plurality of subsets, the plurality of subsets comprising a first subset and a second subset; and a hardware accelerator configured to: obtain a language model; read the plurality of subsets from the memory array; generate, based on the plurality of subsets, a tokenizer of the language model, and an embedding layer of the language model, a plurality of embedding vectors, the plurality of embedding vectors comprising a first embedding vector and a second embedding vector; write the plurality of embedding vectors in the memory array; read, from the memory array, at least one embedding vector associated with a user query from the plurality of embedding vectors; and perform an inference operation that outputs a response associated with the user query, based on the user query, the at least one embedding vector, and the language model.

According to embodiments, a computational storage system is provided, including a host device including a host processor and a host memory connected to the host processor, and a computational storage device configured to communicate with the host processor and generate an output. The computational storage device includes a memory array configured to store a corpus, the corpus comprising a plurality of subsets; and a hardware accelerator configured to: obtain a language model, read the plurality of subsets from the memory array, generate a plurality of embedding vectors based on the plurality of subsets, a tokenizer of the language model, and an embedding layer of the language model, and write the plurality of generated embedding vectors in the memory array. The host processor is configured to index, from the corpus, at least one embedding vector associated with a user query; and transmit, to the computational storage device, at least one identifier associated with the at least one embedding vector. The hardware accelerator is further configured to: read the at least one embedding vector from the memory array based on the at least one identifier of the at least one embedding vector; and perform an inference operation that outputs a response corresponding to the user query based on the user query, the at least one embedding vector, and the language model. The hardware accelerator and the memory array are configured to communicate with each other based on a first protocol; the computational storage device is configured to communicate with the host device based on a second protocol different from the first protocol; and an average communication speed according to the first protocol is greater than an average communication speed according to the second protocol.

### BRIEF DESCRIPTION OF THE DRAWINGS

FIG. 1 illustrates an example of a computational storage system according to embodiments of the present disclosure;

FIG. 2 illustrates an example of a host processor of a computational storage system according to embodiments of the present disclosure;

FIG. 3 illustrates an example of an internal configuration of a computational storage device according to embodiments of the present disclosure;

FIG. 4 illustrates an example of an internal configuration of an accelerator according to embodiments of the present disclosure;

FIG. 5 illustrates an example of an operation of a computational storage device upon a request of a host processor according to embodiments of the present disclosure;

FIG. 6 is a flowchart illustrating an operation method of a computational storage system according to embodiments of the present disclosure;

FIG. 7 is a flowchart that illustrates an embodiment of operation S610 of FIG. 6 in detail;

FIG. 8 illustrates an embodiment of language model data of FIG. 7;

FIG. 9 illustrates an embodiment of operation S620 of FIG. 6 in detail;

FIG. 10 is a flowchart that illustrates an embodiment of operation S630 of FIG. 6 in detail;

FIG. 11 illustrates an example of tokenization and embedding lookup operation of operation S1060 of FIG. 10;

FIG. 12 illustrates an embodiment of a plurality of embedding vectors generated according to a plurality of tokenizations and embedding lookup operations;

FIG. 13 illustrates an example of a relationship table indicating a relationship between an address and an identifier in operation S1090 in FIG. 10;

FIG. 14 illustrates an embodiment of operation S640 of FIG. 6 in detail;

FIG. 15 and FIG. 16 illustrate an embodiment of operation S650 of FIG. 6;

FIG. 17 illustrates an example of performance of a plurality of inference operations in parallel;

FIG. 18 illustrates an embodiment in which a final response is determined based on a local response;

FIG. 19 illustrates an embodiment of operation S660 of FIG. 6; and

FIG. 20 illustrates an embodiment of operation S660 of FIG. 6.

### DETAILED DESCRIPTION

According to embodiments, the embedding conversion on subset for the retrieval augmented generation may not be performed in an inference operation, but an embedding vector converted from a subset in advance before the inference operation (i.e., before a run time) in the inference operation of the language model may be used, thereby accelerating the inference operation which reduces time to first token (TTFT), and effectively preventing the overhead of the accelerator.

According to embodiments, the quality of the response of the language model may be enhanced, and the hallucination of the language model may be reduced.

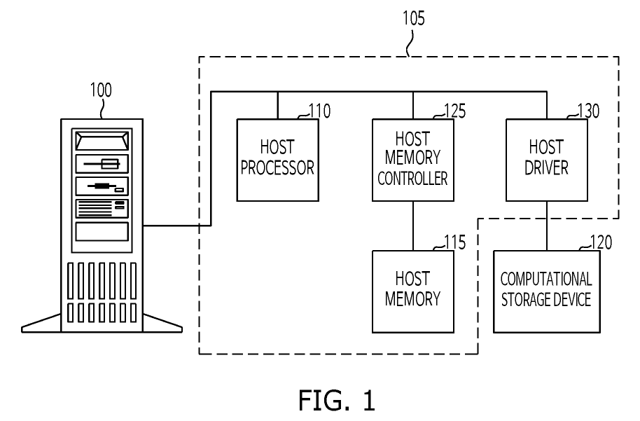

Referring to FIG. 1 to FIG. 20, the embodiments of the present disclosure will be described below. Like reference numerals in the drawings denote like elements throughout the specification.

FIG. 1 is a view illustrated to explain a computational storage system 100 according to embodiments of the present disclosure. The computational storage system 100 may include a host device 105 and a computational storage device 120. Referring to FIG. 1, for ease of explanation, it is described that the host device 105 and the computational storage device 120 are placed outside a computational storage system 100, but the host device 105 and the computational storage device 120 may be included inside the computational storage system 100.

The host device 105 may include a host processor 110 and a host memory 115. The host processor 110 may control the overall operation of the host device 105. For example, the host processor 110 may be implemented as a central processing unit (CPU), an application processor (AP), a graphic processing unit (GPU), a neural processing unit (NPU), a field-programmable gate array (FPGA), or at least one of various processing units including a microprocessor. In addition, the host processor 110 may be implemented as a system-on-a-chip (SoC).

The host processor 110 may consist of a single processor or any number of processors. The host processor 110 may consist of a reduced instruction set computer (RISC) architecture, a complex instruction set computer (CISC) architecture, or a combination thereof. The host processor 110 may be a single core processor or a multi-core processor.

The host processor 110 may be connected to the host memory 115. The host memory 115 may store data, commands, or programs required for the operation of the host processor 110. According to embodiments, the host memory 115 may be used for storing short-term data. The short-term data may indicate data that is not to be stored for a long term. The examples of the short-term data may include a temporary file, a cache, etc.

The host processor 110 may support an operating system in which various applications are executed. An application may generate a read request or a write request for the host memory 115. A host memory controller 125 may manage data transmission between the host processor 110 and the host memory 115 based on the requests generated by an application.

The host processor 110 may communicate with the computational storage device 120 through a host driver 130. The host device 105 (or, the host processor 110) and the computational storage device 120 may communicate based on the Peripheral Component Interconnect express (PCIe) protocol, but the present disclosure is not limited thereto. For example, the host processor 110 and the computational storage device 120 may communicate based on various protocols such as Non-Volatile Memory Express (NVMe), NVMe over Fabrics (NVMe-oF), Remote Direct Memory Access (RDMA), Transmission Control Protocol/Internet Protocol (TCP/IP), Universal Flash Storage (UFS), embedded MultiMediaCard (eMMC), InfiniBand, Serial Attached Small Computer System Interface (SAS, SCSI), Internet SCSI (iSCSI), Serial AT Attachment (SATA), etc.

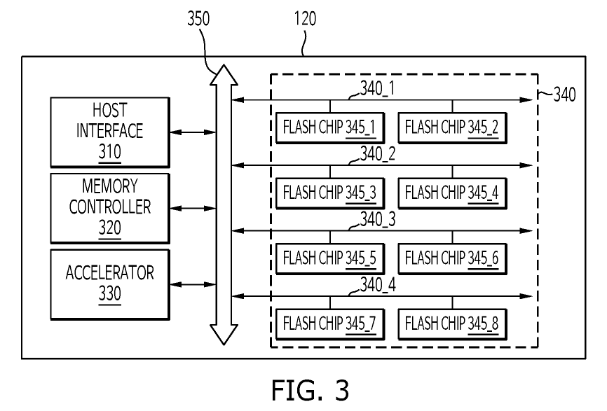

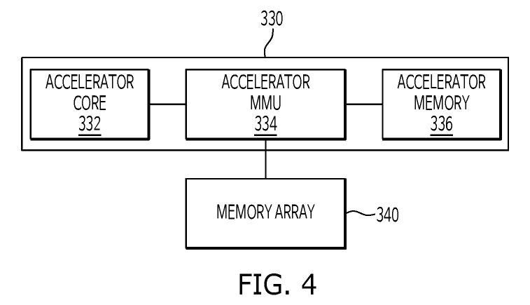

The computational storage device 120 may be a device that provides computational services and data storage services. In FIG. 1, the computational storage system 100 is illustrated as including one computational storage device 120, but is not limited thereto, but the computational storage system 100 may include a plurality of computational storage devices. The computational storage device 120 may include a solid state drive (SSD), a hard disk drive (HDD), a solid state hybrid drive (SSHD), etc. The internal configuration of the computational storage device 120 will be described in detail below with reference to FIG. 3 and FIG. 4.

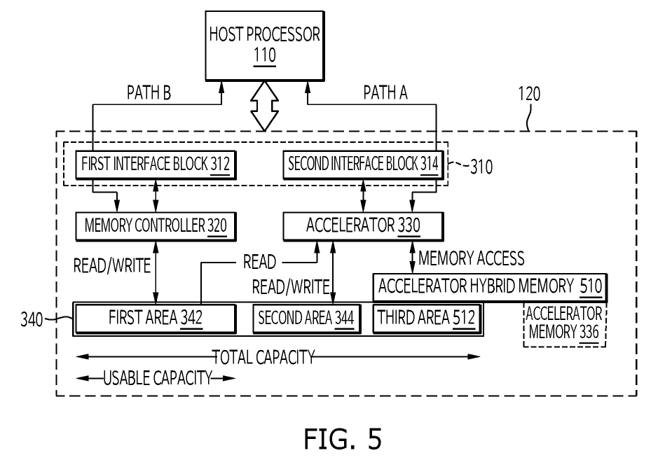

The computational storage device 120 may generate an output for a request received from the host processor 110. For example, the computational storage device 120 may read data stored in the computational storage device 120 in response to a read request received from the host processor 110. The computational storage device 120 may store data in the computational storage device 120 in response to a write request received from the host processor 110. The example where the computational storage device 120 operates in response to a request received from the host processor 110 will be detailed with reference to FIG. 5.

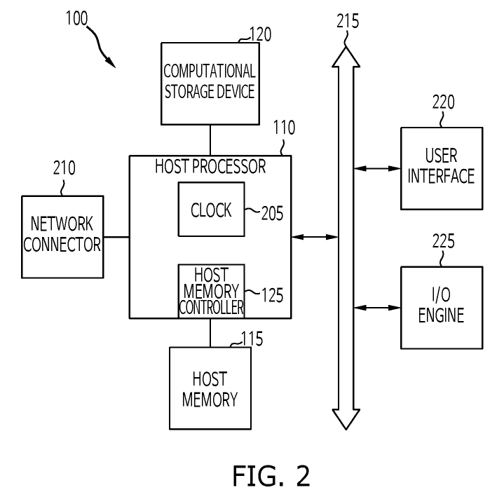

FIG. 2 is a view illustrated to explain a host processor 110 of a computational storage system 100 in detail according to embodiments of the present disclosure. The computational storage system 100 may include the host processor 110. The host processor 110 may control the overall operation of the computational storage system 100.

The host processor 110 may include a host memory controller 125 and a clock 205. The host memory controller 125 may manage data transmission between the host processor 110 and the host memory 115. The clock 205 may synchronize the operations of the host processor 110 and the host memory 115.

The host processor 110 may be connected to the host memory 115. The host memory 115 may be a volatile memory, a non-volatile memory, or a combination thereof. For example, the host memory 115 may include a volatile memory such as dynamic random-access memory (DRAM), static random-access memory (SRAM), etc. and/or a non-volatile memory such as electrically erasable programmable read-only memory (EEPROM), ferroelectric random-access memory (FRAM), phase-change random-access memory (PRAM), magneto-resistive random-access memory (MRAM), flash memory, etc.

The host processor 110 may be connected to the computational storage device 120. The host processor 110 may transmit and receive data to and from the computational storage device 120. For example, the host processor 110 may transmit a request for performing a specific operation to the computational storage device 120. The computational storage device 120, in response to receiving a request from the host processor 110, may perform the operation related to the request, and return the data generated by performing the operation to the host processor 110 as a response to the request.

The host processor 110 may be connected to a network connector 210. The host processor 110 may connect to an external network through the network connector 210.

The network connector 210 may be implemented as an Ethernet connector, a wireless connector, etc., but the present disclosure is not limited thereto.

The host processor 110 may be connected to a user interface 220 and an input and output engine 225 through a bus 215. The host processor 110 may receive input data from the user interface 220 through the bus 215, and generate output data for the received input data. For example, the host processor 110 may receive a user query from the user interface 220. For example, the host processor 110 may receive a user query in text form. According to embodiments, the user query may be in the form of a question, or request for a specific operation or information, but the present disclosure is not limited thereto.

The host processor 110 may control the computational storage device 120 to generate a response corresponding to a user query by analyzing the user query using a language model (e.g., LLM). For example, the computational storage device 120 may receive a user query received through the user interface 220 from the host processor 110, generate a response corresponding to the user query, and transmit the response to the host processor 110. The host processor 110 may output the generated response through the user interface 220.

The host processor 110, based on a user query, may extract a context or a subset related to the user query from a corpus stored in an external database and/or the computational storage device 120, and input the extracted context or subset and the user query into the language model as a prompt. The host processor 110 may generate a response of the language model by using not only a user query but also external information related to the user query, thereby enhancing the quality of the response of the language model, and reducing the hallucination of the language model.

The input and output engine 225 may support a process of data being input or output through the bus 215. For example, the input and output engine 225 may reduce the overhead and bottleneck of the host processor 110 that may occur when the host processor 110 directly controls data input and output operations.

FIG. 3 is a view illustrating an internal configuration of a computational storage device 120 according to embodiments of the present disclosure. The computational storage device 120 may include a host interface 310, a memory controller 320, a hardware accelerator 330 (referred to ‘accelerator’), and a memory array 340.

The host interface 310 may connect a host processor (e.g., host processor 110 of FIG. 1) and a memory controller 320. The host interface 310 may connect a host processor to the accelerator 330. For example, the host interface 310 may include a first interface block and a second interface block, the host processor and the memory controller 320 may be connected through the first interface block, and the host processor and the accelerator 330 may be connected through the second interface block. The detailed description thereof will be made with reference to FIG. 5. The host interface 310 may transmit a request received from the host processor to each of the memory controller 320 and the accelerator 330.

The memory controller 320 and the accelerator 330 may access the memory array 340. For example, each of the memory controller 320 and the accelerator 330 may perform a read operation and/or a write operation for the memory array 340 based on a request received from the host processor, and transmit or receive data to or from the memory array 340. The memory controller 320 and the accelerator 330 each may perform or complete a request from the host processor for different areas of the memory array 340. The memory controller 320 may be limited to access a specific area of the memory array 340. A specific example thereof will be detailed below with reference to FIG. 5.

The memory array 340 may include a non-volatile memory. For example, the memory array 340 may include a NAND flash memory, and may be implemented in various forms such as a 2D NAND memory array, a Vertical NAND (VNAND) memory array, etc. However, the type of memory included in the memory array 340 is not limited thereto, but may be various non-volatile memories such as an electrically erasable programmable read-only memory (EEPROM), a ferroelectric random-access memory (FRAM), a phase-change random-access memory (PRAM), a magneto-resistive random-access memory (MRAM), etc.

The memory array 340 may include a plurality of flash chips 345_1 to 345_8. Each of the plurality of flash chips 345_1 to 345_8 may be implemented as an arbitrary memory unit that operates according to an individual request of the memory controller 320. In FIG. 3, the memory array 340 is illustrated as being implemented as the plurality of flash chips 345_1 to 345_8, but is not limited thereto, but may be implemented in various forms such as dies or packages.

Each of the plurality of flash chips 345_1 to 345_8 may be connected to any one of a plurality of channels 340_1 to 340_4. For example, each of flash chips 345_1 and 345_2 may be connected to a first channel 340_1, and each of flash chips 345_3 and 345_4 may be connected to a second channel 340_2. In FIG. 3, the memory array 340 is illustrated as including eight flash chips 345_1 to 345_8 connected through four channels 340_1 to 340_4, but the present disclosure is not limited thereto. The memory array 340 may include any number of flash memory chips connected through any number of channels.

Each of the memory controller 320 and the accelerator 330 may transmit or receive data to or from the memory array 340 through the plurality of channels 340_1 to 340_4. For example, the memory controller 320 may transmit or receive data to or from the memory array 340 through at least part of the plurality of channels 340_1 to 340_4. In embodiments, the accelerator 330 may similarly transmit or receive data to or from the memory array 340 through at least part of the plurality of channels 340_1 to 340_4.

Each of the memory controller 320 and the accelerator 330 may transmit and receive data in parallel to or from the memory array 340 through a plurality of channels. For example, the memory controller 320 may transmit and receive data through a first channel 340_1 and a second channel 340_2 simultaneously. According to another example, the accelerator 330 may transmit and receive data through a third channel 340_3 and a fourth channel 340_4 simultaneously. According to yet another example, the memory controller 320 may transmit and receive data through the first channel 340_1, and the accelerator 330 may transmit and receive data through the second channel 340_2 simultaneously.

The host interface 310, the memory controller 320, the accelerator 330, and the memory array 340 may be connected to communicate with one another through the bus 350. A protocol used for communication of the bus 350 may be different from a protocol used for communication between a host device (e.g., host device 105 of FIG. 1) and the computational storage device 120. For example, the average communication speed according to the protocol used for communication of the bus 350 may be greater than the average communication speed according to the protocol used for communication between the host device and the computational storage device 120. As a specific example, the memory controller 320, the accelerator 330, and the memory array 340 may communicate with one another based on the Advanced eXtensible Interface (AXI) protocol, and the host device and the computational storage device 120 may communicate with each other based on the PCIe protocol.

FIG. 4 is a view illustrated to explain an internal configuration of an accelerator 330 according to embodiments of the present disclosure. The accelerator 330 may refer to a hardware accelerator. The accelerator 330 may be implemented in various forms such as a graphics processing unit (GPU), a field-programmable gate array (FPGA), a tensor processing unit (TPU), an application-specific integrated circuit (ASIC), a neural processing unit (NPU), a general-purpose GPU (GPGPU), etc.

The accelerator 330 may include an accelerator core 332, an accelerator memory management unit (referred to as Accelerator MMU in FIG. 4) 334, and an accelerator memory 336.

The accelerator core 332 may perform a computation associated with a request received from a host processor (e.g., host processor 110 of FIG. 1). For example, the host processor may request registration or execution of a program including a data flow graph (DFG). The accelerator core 332 may perform a computation on data related to a program registration request or a program execution request.

Referring to FIG. 4, the accelerator 330 is illustrated as including one accelerator core 332, but is not limited thereto. For example, the accelerator 330 may include a plurality of accelerator cores, and the plurality of accelerator cores may perform operations in parallel.

The accelerator memory management unit 334 may perform a read request or write request with respect to data required for computation based on the data flow graph. The accelerator memory 336 may store data that allows the accelerator core 332 to perform computations.

The accelerator memory management unit 334 may communicate with the memory array 340. The accelerator memory management unit 334 may be connected to the memory array 340 and load data required for computation to the accelerator memory 336, or store the data in the accelerator memory 336 in the memory array 340.

According to embodiments, the accelerator memory 336 may be a volatile memory, and the memory array 340 may be a non-volatile memory. As a specific example, the accelerator memory 336 may be a DRAM, and the memory array 340 may be a NAND flash memory, but the present disclosure is not limited thereto. The accelerator memory 336 may be used when high-speed data access is required in the accelerator 330, such as when temporarily storing data frequently referenced during the computational process of the accelerator 330, or an intermediate calculation result, etc.. The memory array 340 may be used to store a relatively large amount of data.

The performance of the computational storage system (e.g., 100 of FIG. 1) may be improved and the effective data storage structure may be achieved by caching the data frequently used by the accelerator 330 (e.g., model weights) in the accelerator memory 336, and storing data that does not require real-time data processing (e.g., preprocessed data from a corpus) in the memory array 340.

In embodiments, the accelerator memory 336 may be a byte addressable memory capable of reading and writing data by specifying an address in units of bytes, and the memory array 340 may be a page addressable memory capable of reading and writing data in units of pages.

FIG. 5 is a view illustrating an example where a computational storage device 120 operates according to a request from a host processor 110 according to embodiments of the present disclosure. The computational storage device 120 may include a host interface 310, a memory controller 320, an accelerator 330, and a memory array 340.

The host interface 310 may include a first interface block 312 and a second interface block 314. The host interface 310 may be circuitry, and the first interface block 312 and the second interface block 314 may separate circuitry or integrated circuitry. According to an embodiment, the first interface block 312 and the second interface block 314 each may be different chips in the host interface 310. According to another embodiment, the first interface block 312 and the second interface block 314 each may be implemented through different firmware for a single chip in the host interface 310.

The host processor 110 may communicate with the memory controller 320 and the accelerator 330 through the host interface 310. For example, the host processor 110 may communicate with the memory controller 320 through the first interface block 312 (Path B) and communicate with the accelerator 330 through the second interface block 314 (Path A). A host driver (e.g., host driver 130 of FIG. 1) that mediates the communication between the host processor 110 and the host interface 310 may include a driver stack to communicate with the memory controller 320 through the first interface block 312 and a driver stack to communicate with the accelerator 330 through the second interface block 314.

The first interface block 312 may transmit the request received from the host processor 110 to the memory controller 320. The memory controller 320 may access the memory array 340 for performing the received request. The second interface block 314 may transmit the request received from the host processor 110 to the accelerator 330. The accelerator 330 may access the memory array 340 to perform the request received from the host processor 110.

The memory array 340 may include a storage space divided into a plurality of areas. Each of the plurality of areas may be referred to as ‘namespace’, and the data may be stored in each of the plurality of areas in the form optimized for the corresponding namespace,

The plurality of areas of the memory array 340 may include a first area 342 that allows direct access by the host processor 110, and a second area 344 that limits direct access by the host processor 110. The memory controller 320 may access the first area 342, but the memory controller 320 may have restricted access to the second area 344. However, the accelerator 330 may access both the first area 342 and the second area 344.

The first area 342 may be a storage space related to a usable capacity disclosed to a host device (e.g., host device 105 of FIG. 1) out of the total capacity of the memory array 340. The second area 344 may be a storage space that is not open to the host device, and may refer to a storage space for performing its own computation in response to a specific request received from the host processor 110.

The memory controller 320 may perform or execute a first-type request of the host processor 110 received through the first interface block 312. The first-type request may be related to the first area 342 of the memory array 340. For example, the memory controller 320 may perform a read request of user data that loads user data stored in the first area 342, or a write request of user data that stores user data in the first area 342.

The accelerator 330 may perform or execute a second-type request of the host processor 110 received through the second interface block 314. The second-type request may be related to the second area 344 of the memory array 340. The second-type request may be a program registration request or a program execution request for a program including the data flow graph (DFG). The accelerator 330 may perform a request related to the second area 344 by providing an application binary interface (ABI) related to the execution of the program.

As a specific example, the accelerator 330 may perform a tensor write request that stores a tensor generated during the process of executing a program in the second area 344. The accelerator 330 may perform a tensor read request that loads a tensor required for executing the program from the second area 344. When a tensor required for executing the program is stored in the first area 342, the accelerator 330 may perform a tensor read request that loads the corresponding data from the first area 342. The tensor loaded from the first area 342 may be stored back in the second area 344 when needed.

The host processor 110 may determine the size of the storage space to be used by each area when the first area 342 and the second area 344 of the memory array 340 are defined. The host processor 110 may determine the sizes of storage spaces of the first area 342 and the second area 344 based on a ratio between the capacity of user data accessed by the memory controller 320, and the capacity of data used for performing computation by the accelerator 330.

According to embodiments, the memory array 340 may further include a third area 512. The third area 512 may be allocated as a swap space for the accelerator 330. The third area 512 may be used as a backup(or reserved) space used when the capacity of the accelerator memory 336 is out of capacity (or insufficient). The accelerator memory 336 of the accelerator 330 and the third area 512 of the memory array 340 may be implemented as an accelerator hybrid memory 510. An accelerator memory management unit (e.g., accelerator MMU 334 of FIG. 4) of the accelerator 330 may access the accelerator memory 336 or the third area 512 to perform a read request or a write request for the tensor related to program execution.

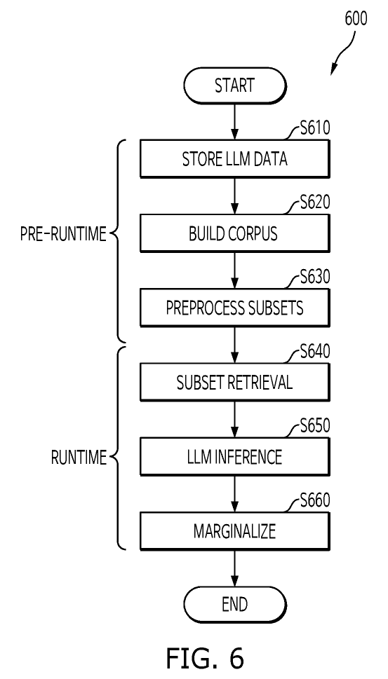

FIG. 6 is a flowchart illustrating an operation method 600 of a computational storage system according to embodiments of the present disclosure. The operation method 600 of FIG. 6 may be performed by a computational storage system (e.g., 100 of FIG. 1).

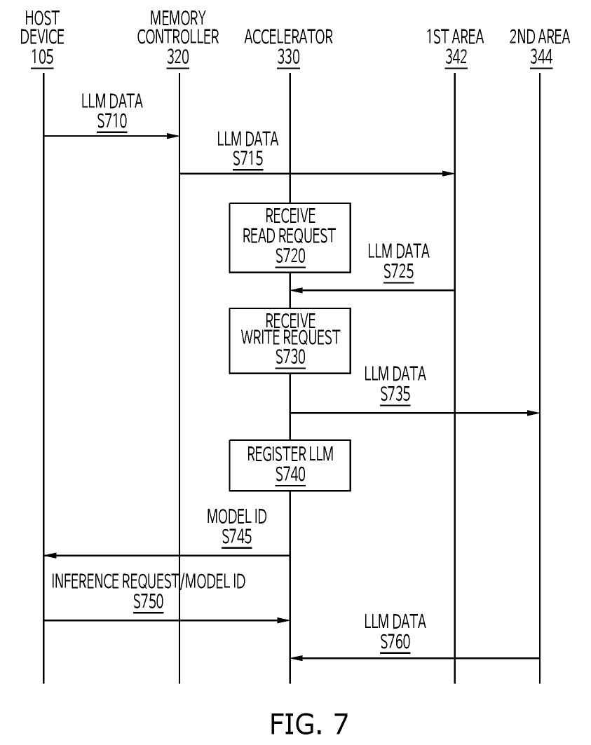

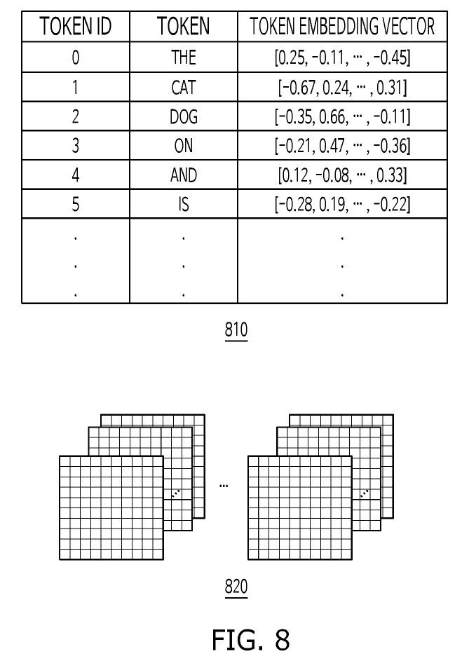

The computational storage system may store language model data in operation S610. For example, the computational storage system may load a language model to be executable in an environment by storing language model data including parameters such as weights that constitute the language model, embedding data, etc. According to embodiments, the language model data may be stored in a memory array (340 of FIG. 3), and loaded into an accelerator (or an accelerator memory) before the inference operation using the language model is initiated. The language model may be a model used for the retrieval augmented generation (RAG). The specific process of storing language model data and the specific structure of language model data will be described in detail below with reference to FIG. 7 and FIG. 8.

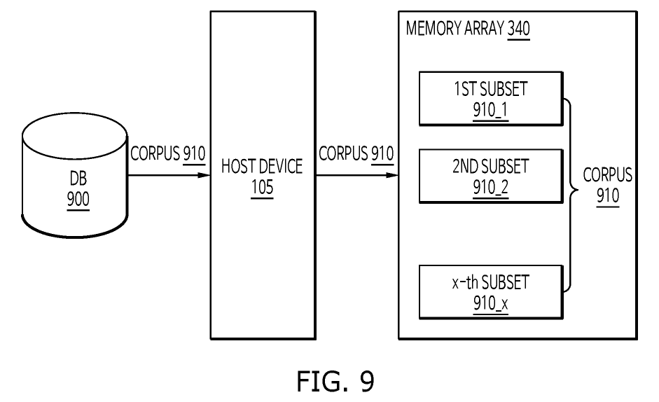

The computational storage system may establish a corpus in operation S620. The corpus may be a set of a large amount or number of texts of a specific language, which may include text data in various fields (e.g., medical, legal, technical fields, etc.). The computational storage system may perform web crawling, or extract data from a database that stores a corpus, thereby storing or establishing the corpus. The corpus may include a plurality of subsets. The corpus may be divided into units of subsets. The process of establishing the corpus and the subsets included in the corpus will be described in detail with reference to FIG. 9.

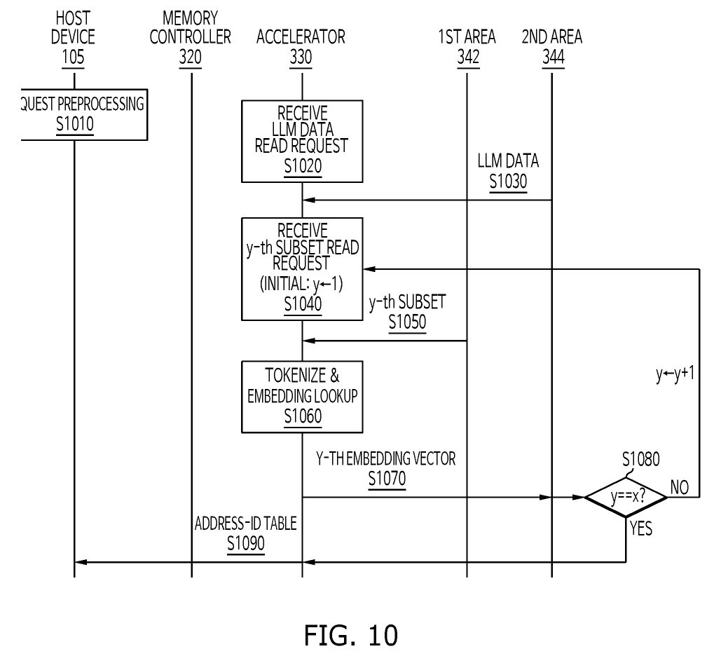

The computational storage system (or, a computational storage device) may perform preprocessing of subsets of the established corpus in operation S630. For example, the computational storage system may preprocess the subsets by performing tokenization and embedding lookup operation on the subsets. The description of operation S630 will be detailed with reference to FIG. 10 to FIG. 13.

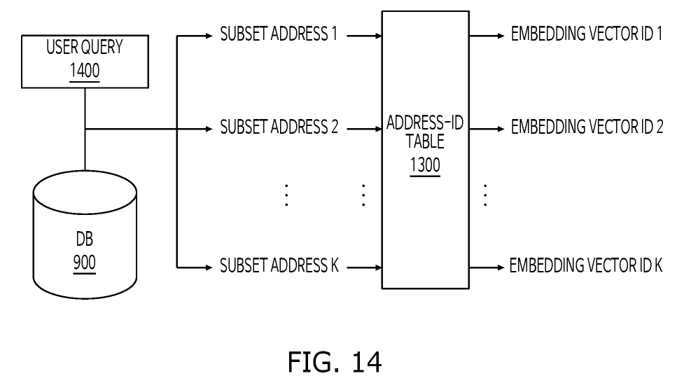

The computational storage system (or a host device) may retrieve a specific subset from the corpus in operation S640. The computational storage system may receive a user query and retrieve a subset related to the user query among a plurality of subsets included in the corpus. The computational storage system may retrieve a subset similar to or highly relative to the user query to generate a response to the user query, and input the subset into the language model with the user query, which allows the language model to generate more accurate and highly relative response. The retrieved subset and user query may be input to the language model as a prompt. The description of operation S640 will be detailed with reference to FIG. 14.

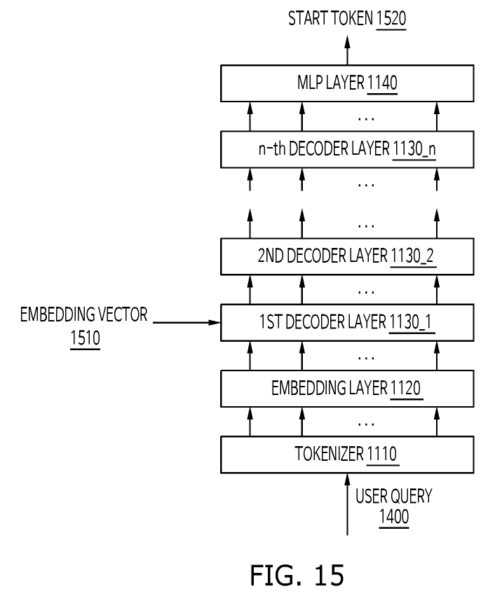

In operation S650, the computational storage system (or, a computational storage device) may perform an inference operation based on the received user query and each of the subsets retrieved in operation S640. The inference operation may include an operation to output a response corresponding to the user query by using a trained language model. The specific example of the inference operation will be described in detail with reference to FIG. 15 to FIG. 17.

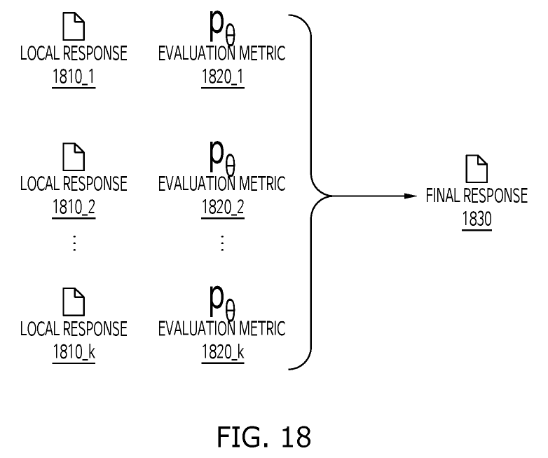

In operation S660, the computational storage system (or a host device) may perform a marginalization operation on the result of the inference operation performed in operation S650. For example, a plurality of inference operations may be performed in operation S650, and a final response of the plurality of inference operations may be selected by the marginalization operation. This will be explained in detail with reference to FIG. 18 to FIG. 20.

Operation S610 to operation S630 in FIG. 6 may be performed in a pre-runtime (e.g., prior to the runtime) of the retrieval augmented generation process. In operation S630, the subsets may be preprocessed in a pre-runtime, which may accelerate the inference operation on the language model in a runtime (e.g., during runtime).

Operation S640 to operation S660 in FIG. 6 are related to the retrieval augmented generation process and may be performed during the runtime.

FIG. 7 is a flowchart illustrated to explain operation S610 of FIG. 6 in detail.

The host device 105 may transmit language model data to the memory controller 320 in operation S710. The language model data may refer to a set of data required for the operation of the language model. For example, the language model data may include parameters such as weights of the language model and embedding data.

The memory controller 320 may transmit the received language model data to the first area 342 of the memory array in operation S715.

The accelerator 330 may receive a read request in operation S720, and read language model data from the first area 342 in response to receiving the read request in operation S725. The read language model data may be stored in an accelerator memory (e.g., accelerator memory 336 of FIG. 4) in the accelerator 330.

The accelerator 330 may receive a write request in operation S730, and write the language model data in the second area 344 in response to receiving the write request in operation S735. For example, the accelerator 330 may write parameters of the language model in the second area 344. The language model data may be stored in the second area 344 in the optimized form. For example, the language model data may be stored in the namespace associated with the accelerator in the optimized form.

The accelerator 330 may register a language model in operation S740. The accelerator 330 may assign an identifier to the language model, and link the assigned identifier to information associated with the language model data (e.g., an identifier of a tensor constituting the language model data, etc.) to register the language model.

The accelerator 330 may return an identifier (ID) of the registered language model to the host device 105 after registering the language model in operation S745.

The host device 105 may transmit an identifier of the language model to the accelerator 330 along with an inference request in operation S750. The accelerator 330 may load the language model to the accelerator 330 by reading language model data specified by an identifier of the language model (e.g., parameters of the language model) from the second area 344 in response to receiving an inference request and an identifier of the language model in operation S760.

The accelerator 330 may perform an inference operation by using the loaded language model.

The operation of the accelerator 330 illustrated and described with reference to FIG. 7 may be performed by a memory management unit (e.g., accelerator MMU 334 of FIG. 4) and the language model data may be stored in an accelerator memory (e.g., accelerator memory 336 of FIG. 4).

FIG. 8 is a view illustrating an example of language model data in FIG. 7.

Referring to FIG. 8, embedding data 810 of language model data may include a token identifier (token ID), a token, and a token embedding vector. The token identifier may be an identifier for uniquely identifying tokens such as words, subwords, symbols, etc., and the token embedding vector may be a continuous real value vector for expressing tokens in a high-dimensional vector space. For example, a token “cat” may be expressed as a token embedding vector, which may indicate the semantic characteristic of the word in the vector space. In the vector space, a word “dog,” which is similar to “cat,” may be located close to each other in the vector space, so that the language model may be trained on the semantic similarity between the words. The token embedding vector may be trained to reflect the grammatical relationships or syntactic patterns in addition to the simple meanings, and finely and precisely adjusted in consideration of use in various contexts.

When each token is converted into an embedding vector, the language model may be trained on contextual relationships between words through a neural network. The token embedding vectors may be continuously updated during the training process of the language model, which may contribute to understanding and generating more sophisticated language expressions. In FIG. 8, the embedding data 810 is illustrated in table format, but is not limited thereto.

Weight data 820 may be parameters used in the neural network layers after an embedding vector is generated, and stored in various mathematical structures such as a matrix, a vector, a tensor, etc. The weight data 820 may be applied to a token embedding vector when the token embedding vector is transmitted to the next layer (e.g., a decoder layer, etc.). The weight data 820 may be used to learn contextual meanings or patterns. Specifically, a weight may be assigned to each layer in a multilayer neural network, so that the language model may identify more complex patterns and relationships.

The weight data 820 may be expressed in the matrix form indicating connections between nodes in each layer, or as a tensor of three (3) or more dimensions. The tensor may be a parameter designed to process multiple channels or sequences simultaneously, and the weight data 820 may expand from a simple matrix to a multidimensional tensor to process and learn various data patterns.

FIG. 9 is a view illustrated to explain operation S620 of FIG. 6 in detail.

The host device 105 (or a host processor) may extract a corpus 910 from a database 900 (e.g., an external database) that stores the corpus 910. For example, the host device 105 may write a query to extract necessary data (e.g., data satisfying specific conditions) from the database 900, transmit the query to the database 900, and receive the corpus 910 from the database 900.

The host device 105 (or a host processor) may establish the corpus 910 in the memory array 340. The corpus 910 may be stored in a first area (e.g., first area 342 of FIG. 5) of the memory array 340.

The corpus 910 may include a plurality of subsets 910_1 to 910_x (where x is a natural number greater than or equal to 2). For example, a set of a plurality of subsets 910_1 to 910_x may be referred to as the corpus 910. Each of the plurality of subsets 910_1 to 910_x may include a predetermined number of tokens (e.g., 100) or one or more paragraphs or pages, but the present disclosure is not limited thereto.

According to embodiments, the host device 105 (or a host processor) may structure and store the plurality of subsets 910_1 to 910_x along with identifiers(e.g., unique identifiers) in the memory array 340. For example, the host device 105 may correspond the addresses of each of the plurality of subsets 910_1 to 910_x to the identifier of each of the plurality of subsets 910_1 to 910_x .

The host device 105 (or a host processor) may apply natural language processing techniques such as tokenization, stop-word removal, and stemming before storing the plurality of subsets 910_1 to 910_x in the memory array 340 and store the plurality of subsets in the memory array 340.

FIG. 10 is a flowchart illustrated to explain operation S630 of FIG. 6 in detail.

The host device 105 may request preprocessing of a plurality of subsets in operation S1010. For example, the host device 105 may request preprocessing of the plurality of subsets by requesting execution of a subset preprocessing program. In response to the host device 105 requesting execution of the subset preprocessing program, the subset preprocessing program may be executed, and a read request for language model data of the subset preprocessing program (e.g., tokenizer data and embedding layer data of the language model) may be transmitted to the accelerator 330.

The accelerator 330 may receive a request to read the language model data (e.g., tokenizer data and embedding layer data of the language model) in operation S1020. In response to receiving the request to read the language model data (e.g., tokenizer data and embedding layer data of the language model), the accelerator 330 may read the language model data (e.g., tokenizer data and embedding layer data of the language model) from a memory array in operation S1030. The accelerator 330 may read the language model data (e.g., tokenizer data and embedding layer data of the language model) from a memory array (e.g., second area 344), and load the language model (e.g., tokenizer and embedding layer of the language model) into the accelerator 330 (or an accelerator memory).

The accelerator 330 (or, an accelerator memory) may receive a request to read a first subset of the subset preprocessing program in operation S1040, and in response to receiving the first subset read request, read the first subset from a memory array in operation S1050. The first subset may be read from the first area 342 of the memory array.

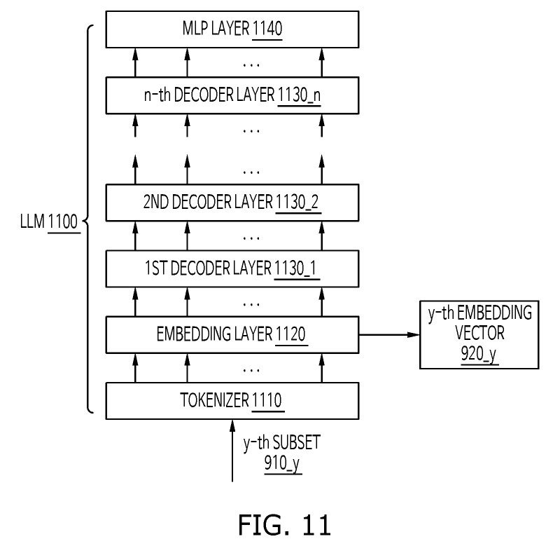

The accelerator 330 may perform tokenization and embedding lookup operation for the first subset in operation S1060. The accelerator 330 may generate a first embedding vector corresponding to the first subset and record the first embedding vector in the memory array in operation S1070 by performing the tokenization and embedding lookup operation for the first subset. For example, the accelerator 330 may generate an embedding vector corresponding to the first subset by inputting the first subset into the language model loaded to the accelerator 330 (e.g., inputting the first subset into the tokenizer of the language model and through an embedding layer). The description thereof will be detailed below with reference to FIG. 11. The accelerator 330 may record the generated first embedding vector in the second area 344 of the memory array.

Operations S1040 to S1070 may be repeatedly performed until tokenization and embedding lookup operation on all or part of the subsets stored in the memory array are performed. For example, the accelerator 330 may receive a request to read a yth subset (where y is a natural number greater than or equal to 2) in operation S1040, read the yth subset from the first area 342 of the memory array in response to receiving the request to read the yth subset, perform the tokenization and embedding lookup operation on the read yth subset to generate a yth embedding vector and write the yth embedding vector in the second area 344 of the memory array. When the yth subset is not the last subset (e.g., an xth subset, where x is a natural number greater than or equal to y) in operation S1080, the same process may be repeatedly applied to the next subset. The tokenization and embedding lookup operation may be performed on a plurality of subsets (e.g., subsets 910_1 to 910_x in FIG. 9) stored in the first area 342 of the memory array.

Therefore, the accelerator 330 may read a plurality of subsets from the memory array, input the plurality of subsets into the language model loaded to the accelerator 330 (e.g., inputting the plurality of subsets into the tokenizer of the language model and through an embedding layer), generate a plurality of embedding vectors corresponding to the plurality of subsets, and write the plurality of generated embedding vectors in the memory array. The accelerator 330 may read the plurality of subsets from the first area 342 of the memory array, and write the plurality of embedding vectors generated from the plurality of subsets in the second area 344 of the memory array.

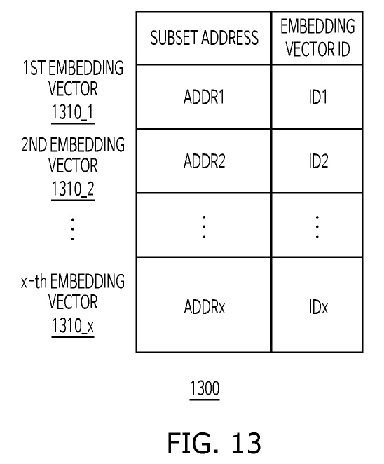

The accelerator 330, in response to performing the tokenization and embedding lookup operation on all or part of the subsets stored in the first area 342 of the memory array, may store a relationship table indicating a relationship between a plurality of identifiers for the plurality of embedding vectors generated from the plurality of subsets through the plurality of tokenizations and embedding lookup operations and a plurality of addresses of the plurality of subsets, and return the relationship table to the host device 105 in operation S1090. The relationship table will be described in detail below with reference to FIG. 13.

The operation of the accelerator 330 described and illustrated with reference to FIG. 10 may be performed by a core (e.g., accelerator core 332 of FIG. 4) and/or a memory management unit (334 of FIG. 4), and language model data (e.g., tokenizer data or embedding layer data of a language model), subsets, etc. may be stored in an accelerator memory (e.g., accelerator memory 336 of FIG. 4).

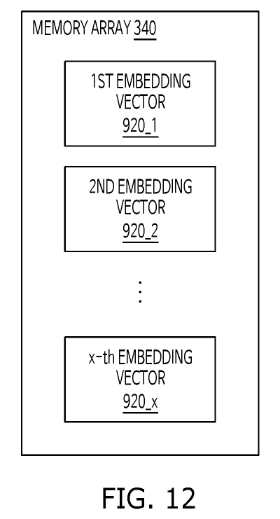

FIG. 11 is a view illustrated to explain tokenization and embedding lookup operation in operation S1060, and FIG. 12 is a view illustrating a plurality of embedding vectors 920_1 to 920_x generated from a plurality of tokenizations and embedding lookup operations.

Referring to FIG. 10 and FIG. 11, a language model 1100 in FIG. 11 may be a model loaded into an accelerator 330.

The language model 1100 may include a tokenizer 1110, an embedding layer 1120, a plurality of decoder layers 1130_1 to 1130_n (where n is a natural number greater than or equal to 2), and a multi-layer perceptron (MLP) layer 1140, but the present disclosure is not limited thereto, part of layers may be added to the language model 1100, or part of layers (e.g., a tokenizer) may be excluded from the language model 1100.

The tokenizer 1110 may tokenize the input text, and output the tokenized text. The tokenizer 1110 may be implemented to use various tokenization techniques to convert the input text to be processed on a different layer of the language model 1100. For example, the tokenizer 1110 may output the tokenized text by using various tokenization techniques such as word-based tokenization that divides words by blanks, subword-based tokenization (byte pair encoding, BPE) that divides words into smaller units, or character-based tokenization that divides text according to specific symbols or rules.

The embedding layer 1120 may output an embedding vector based on the text tokenized from the tokenizer 1110. The embedding layer 1120 may be implemented to use various embedding techniques for outputting embedding vectors. For example, the embedding layer 1120 may use techniques such as one-hot encoding, Word2Vec, GloVe, FastText, etc. as word embedding techniques.

The plurality of decoder layers 1130_1 to 1130_n may receive an embedding vector generated through the embedding layer 1120, receive and process the output from the previous layer, and transmit the output to the next layer. For example, the plurality of decoder layers 1130_1 to 1130_n (where n is a natural number greater than or equal to 2) may be trained on more complex patterns based on the output from the previous layer. An attention mechanism that assigns weights to each token of an input sequence to focus on important information, particularly, a self-attention that allows each token to learn the relationship with each other, and/or a multi-head attention that allows to learn various perspectives on different parts of the input through multiple attention heads may be used.

An MLP layer 1140 may receive the output of a final decoder layer 1130_n and output a response corresponding to the text. For example, the MLP layer 1140 may be used to derive conclusions or generate new information based on the information extracted from the plurality of decoder layers 1130_1 to 1130_n.

Referring to FIG. 10 and FIG. 11, an accelerator 330 may tokenize a yth subset 910_y (y is a natural number greater than or equal to 1) using the tokenizer 1110 in the tokenization and embedding lookup operation in operation S1060, and convert the tokenized yth subset into a yth embedding vector 920_y using the embedding layer 1120.

Referring to FIG. 10 and FIG. 12, as operations S1040 to S1070 are repeatedly performed, a plurality of embedding vectors 920_1 to 920_x may be generated, and the plurality of generated embedding vectors 920_1 to 920_x may be stored in the memory array 340.

FIG. 13 is a view illustrated to explain a relationship table 1300 indicating a relationship between an address and an identifier in operation S1090 of FIG. 10.

The relationship table 1300 may indicate a correspondence relationship between a plurality of addresses ADDR1 to ADDRx of a plurality of subsets, and a plurality of identifiers ID1 to IDx for a plurality of embedding vectors 1310_1 to 1310_x generated from the plurality of subsets. The plurality of embedding vectors 1310_1 to 1310_x may be generated for each subset by the host device, which may be embedding vectors generated using a contextual embedding technique such as bidirectional encoder representations from transformers (BERT).

The plurality of addresses ADDR1 to ADDRx may be addresses of a plurality of subsets in a database (e.g., database 900 of FIG. 9) that stores a plurality of subsets, or addresses of a plurality of subsets stored in a memory array (e.g., memory array 340 of FIG. 9).

An identifier of an embedding vector generated from the subset through the address of a specific subset may be obtained by using the relationship table 1300.

Referring to FIG. 10 and FIG. 13 an accelerator 330, in response to generating a specific embedding vector, may update a relationship table 1300 to add the identifier of the embedding vector and the address of the subset on which the embedding vector is based to the relationship table 1300.

FIG. 14 is a view illustrated to explain operation S640 of FIG. 6 in detail.

The operation illustrated and described with reference to FIG. 14 may be performed by a host device (e.g., host device 105 of FIG. 1), particularly, a host processor (e.g., host processor 110 of FIG. 1) in the host device.

The host processor may obtain at least one subset address (subset addresses 1 to k, where k is a natural number greater than or equal to 1) associated with a user query 1400 from a corpus in the database 900. For example, the host processor may determine a predetermined number of subsets in descending order of similarity (e.g., cosine similarity, etc.) between the embedding vector of the user query and the embedding vector of the subset or in ascending order of distance (e.g., Euclidean distance, Manhattan distance, etc.), and obtain the addresses of the corresponding subsets. According to another example, the host processor may determine a predetermined number of subsets in order of high relevance to the user query by using an approximate nearest neighbor algorithm and obtain the addresses of the corresponding subsets.

The number of subsets associated with the user query may be determined based on various elements. For example, the number of subsets associated with the user query may be determined in consideration of a response generation time and a response accuracy required for the language model. For example, as the language model is required to generate a response with high accuracy, the number of subsets associated with the user query may increase, and as the language model is required to generate a response with high speed, the number of subsets associated with the user query may decrease.

The host processor may obtain the identifier of at least one embedding vector (embedding vectors ID 1 to k) corresponding to at least one subset address (subset addresses 1 to k) based on the relationship table 1300 described with reference to FIG. 13.

The host processor may transmit the identifier of at least one embedding vector (embedding vector ID 1 to ID k) to a computational storage device (e.g., computational storage device 120 of FIG. 1)

The computational storage device (or a hardware accelerator in the computational storage device), in response to receiving the identifier of at least one embedding vector (embedding vectors ID 1 to k), may read at least one embedding vector corresponding to the identifier of the at least one embedding vector (embedding vectors ID 1 to k) from the memory array.

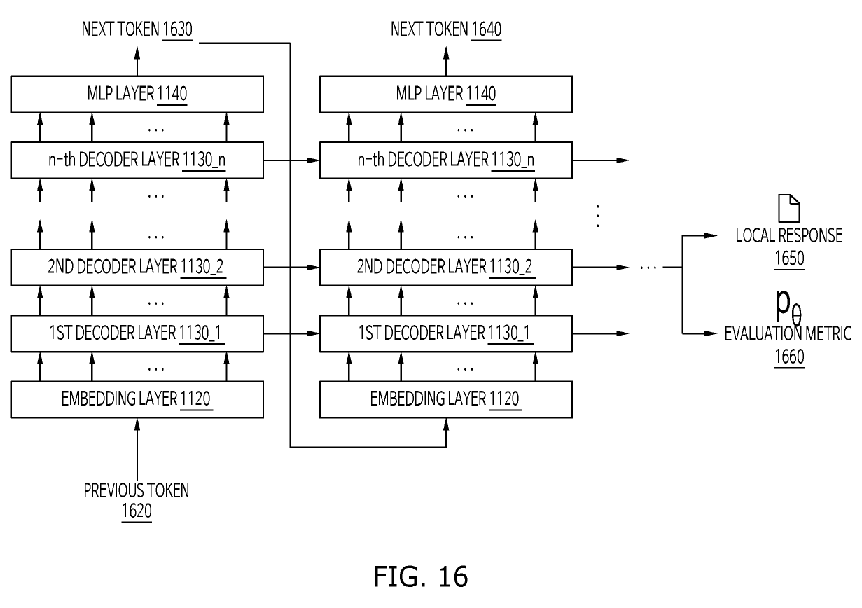

FIG. 15 and FIG. 16 are views illustrated to explain operation S650 of FIG. 6 in detail. The operation illustrated and described with reference to FIG. 15 and FIG. 16 may be performed by an accelerator (e.g., accelerator 330 of FIG. 3) (or, an accelerator core in the accelerator).

Referring to FIG. 15, the accelerator may tokenize a user query 1400 using the tokenizer 1110. The accelerator may convert the tokenized user query into an embedding vector using the embedding layer 1120.

The accelerator may input an embedding vector 1510 converted from a subset and an embedding vector converted from a user query 1400 into a first decoder layer 1130_1 connected to an embedding layer among a plurality of decoder layers 1130_1 to 1130_n. The accelerator may output a start token 1520 of a response corresponding to the user query 1400 based on the embedding vector 1510 converted from the subset and the embedding vector converted from the user query 1400 by the plurality of decoder layers 1130_1 to 1130_n and an MLP layer 1140. The start token may be generated in similarly as when a specific subset and the user query 1400 are input to the language model as a prompt.

The accelerator may input the start token 1520 of the response back into the embedding layer 1120 to generate the next token (or subsequent later token) from the start token 1520.

The embedding vector 1510 converted from the subset may be an embedding vector converted from a subset associated with a user query, for example, an embedding vector read from the memory array by using any one of the identifiers of the embedding vectors ID 1 to k of FIG. 14. The embedding conversion on the subset for the retrieval augmented generation may not be performed, but the embedding vector converted from a subset before an inference operation (e.g., before a runtime) may be used in the inference operation of the language model, thereby accelerating an inference operation such as reducing time to first token (TTFT), and preventing the overhead of the accelerator.

Referring to FIG. 16, the accelerator may input a previous token 1620 (e.g., the start token 1520 of FIG. 15) generated in the MLP layer 1140 into the embedding layer 1120. In response to inputting the previous token 1620 into the embedding layer 1120, the accelerator may generate a next token 1630, which is the subsequent token of the previous token 1620, by the plurality of decoder layers 1130_1 to 1130_n and the MLP layer 1140.

In the same or different embodiment, the accelerator, in response to inputting the token 1630 into the embedding layer 1120, may generate a next token 1640 by the plurality of decoder layers 1130_1 to 1130_n and the MLP layer 1140. This process may be repeated until an end token is generated by the MLP layer 1140. In response to generating the end token, a single inference operation performed using a single subset may be terminated.

As a single inference operation is performed, a single local response 1650 corresponding to the user query, and an evaluation metric 1660 corresponding to the local response 1650 may be output. The output local response 1650 and the evaluation metric 1660 may be transmitted to a host device.

As the evaluation metric 1660, various types of metrics for evaluating the accuracy, suitability, and/or reliability of the local response 1650 may be used. For example, the evaluation metric 1660 may include various metrics such as BLEU, ROUGE, METEOR, Precision@K, and/or Recall@K.

The inference operation illustrated and described with reference to FIG. 15 and 16 may be repeatedly performed by each of the embedding vectors converted from a subset determined to be associated with a user query. For example, the inference operation may be performed k times by using each of k embedding vectors read by using the identifiers of the embedding vectors ID 1 to k of FIG. 14 and the user query.

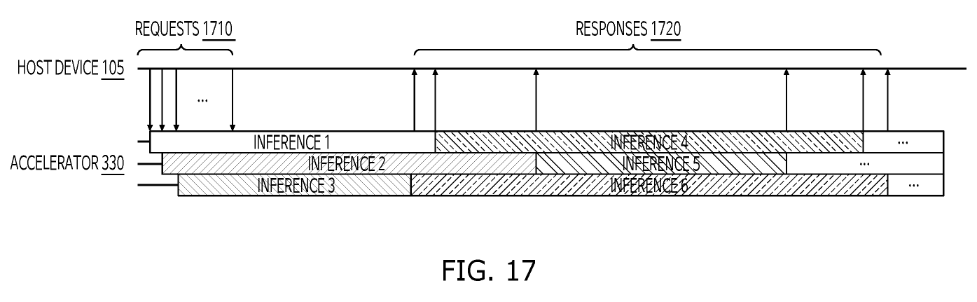

FIG. 17 is a view illustrating an example where a plurality of inference operations are performed in parallel in an accelerator 330. In response to the host device 105 transmitting a plurality of requests 1710 to the accelerator 330, a plurality of inference operations (inferences 1 to 6) may be initiated. Each of the plurality of inference operations (inferences 1 to 6) may correspond to the inference operation described with reference to FIG. 15 and 16, and may be performed by using an embedding vector converted from a subset and a user query.

The accelerator may perform at least part of the inference operation of among a plurality of inference operations (inferences 1 to 6) and at least part of the inference operation of another one of the plurality of inference operations (inferences 1 to 6) in parallel. For example, the accelerator 330 may include a plurality of accelerator cores and each of the plurality of accelerator cores may perform at least one inference operation. While a first core performs a first inference operation (inference 1) that outputs a first response corresponding to a user query based on a user query and a first embedding vector, a second core may perform a second inference operation (inference 2) that outputs a second response corresponding to a user query based on a user query and a second embedding vector.

FIG. 18 is a view illustrating an example of determining a final response 1830 based on local responses 1810_1 to 1810_k. An accelerator (e.g., accelerator 330 of FIG. 3), based on each of k embedding vectors (where k is a natural number equal to or greater than 1 ) and a user query by using the language model loaded to the accelerator, may output k local responses 1810_1 to 1810_k corresponding to the user query and k evaluation metrics 1820_1 to 1820_k corresponding to the k local responses 1810_1 to 1810_k.

The accelerator may transmit k local responses 1810_1 to 1810_k and k evaluation metrics 1820_1 to 1820_k to a host device (e.g., host device 105 in FIG. 1). A host processor (e.g., host processor 110 in FIG. 1) of the host device may determine a local response with the highest evaluation metric among the k local responses 1810_1 to 1810_k as a final response 1830. The host processor may output the determined final response 1830 to an external device (e.g., a user terminal) of the host device.

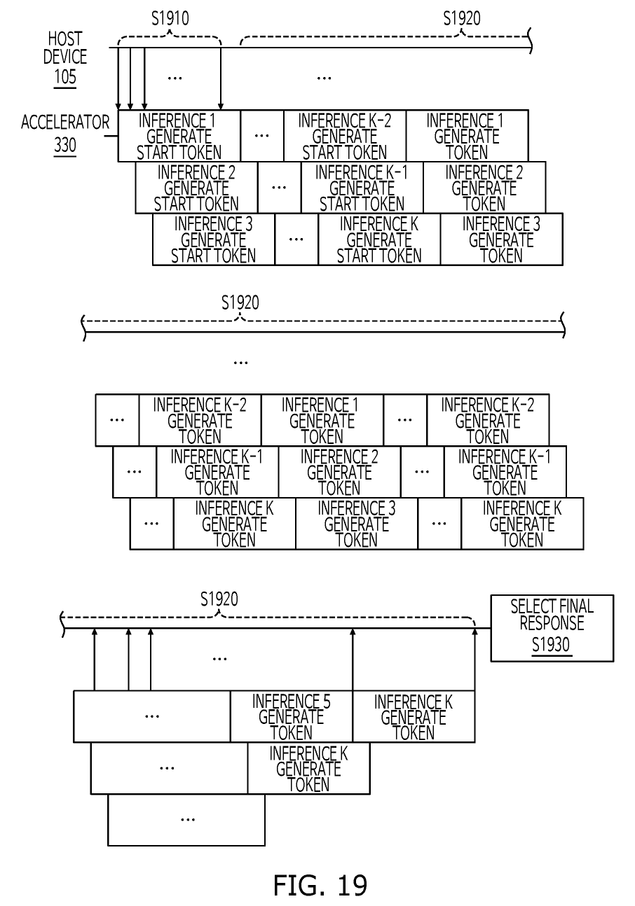

FIG. 19 is a view illustrated to explain an example of operation S660 in FIG. 6.

The process in FIG. 19 may correspond to a process that determines the final response 1830 described with reference to FIG. 15, FIG. 16, and FIG. 18.

The host device 105 may transmit one or more requests to the accelerator 330 in operation S1910. The accelerator 330 may initiate one or more inference operations (inferences 1 to k, where k is a natural number greater than or equal to 1) in response to receiving one or more requests. When one or more inference operations (inferences 1 to k) include a plurality of inference operations, the plurality of inference operations may be performed in parallel on a plurality of accelerator cores of the accelerator 330.

The accelerator 330 may generate a start token in parallel from at least one inference operation, and generate the next token sequentially (or subsequent later token) from the start token , thereby generating at least one or more local responses and transmitting the generated at least one local response to the host device 105 in operation S1920.

The host device 105 may determine a final response from the received at least one local response in operation S1930.

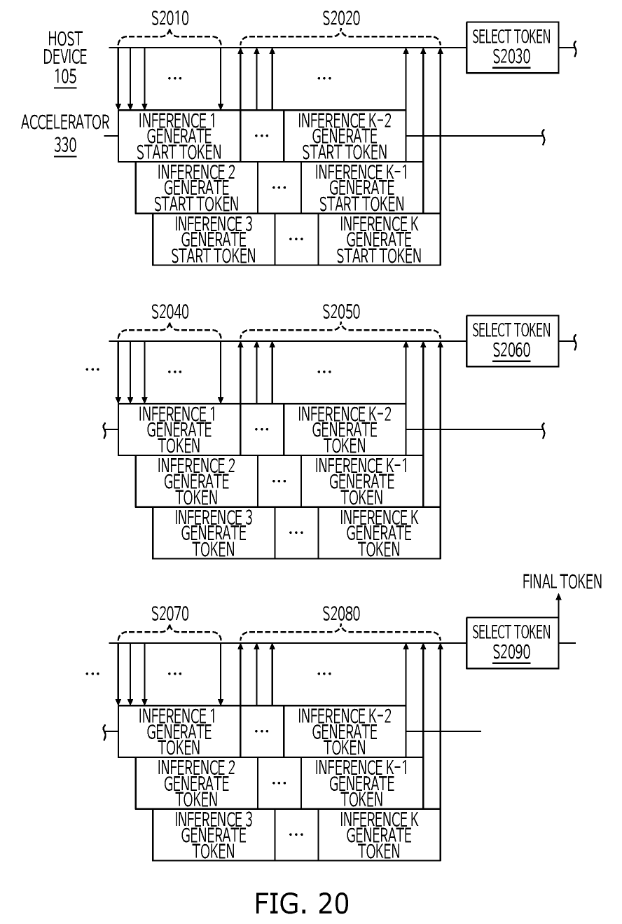

FIG. 20 is a view illustrating another example of operation S660 in FIG. 6.

The host device 105 (or, a host processor) may transmit at least one or more requests to the accelerator 330 in operation S2010. In response to receiving at least one or more requests, the accelerator 330 may initiate at least one or more inference operations (inferences 1 to k). When one or more inference operations (inferences 1 to k) include a plurality of inference operations, the plurality of inference operations may be performed in parallel in a plurality of accelerator cores of the accelerator 330.

The accelerator 330 may output and transmit k start tokens and the evaluation metrics for respective start token to the host device 105 (or a host processor) based on k (where k is a natural number equal to or more than 1) embedding vectors and the user query by using the loaded language model in operation S2020.

The host device 105 (or a host processor) may select a start token with the highest evaluation metric among k start tokens in operation S2030, and transmit the start token to the accelerator 330 (or a plurality of accelerator cores) in operation S2040.

The accelerator 330 may output k next tokens and evaluation metrics for the respective k next tokens to the host device 105 based on the start token with the highest evaluation metric by using the loaded language model in operation S2050.

The host device 105 (or a host processor) may determine the next token (or subsequent later token) with the highest evaluation metric as the next token from the start token with the highest evaluation metric in operation S2060.

The accelerator 330 and the host device 105 may perform the above-described process repeatedly. For example, the host device 105 may transmit the token with the highest evaluation metric to the accelerator 330 in operation S2070, and in response to the transmission, the accelerator 330 may output and transmit k tokens and k evaluation metrics to the host device 105 in operation S2080, and the host device 105 may select any one of the k tokens in operation S2090. When the token selected by the host device 105 is a final token, the final response may be determined by the set of the tokens selected by the host device 105.

While the present disclosure has been described with reference to exemplary embodiments thereof, but it is not limited to thereto. It will be apparent to those skilled in the art that various modifications and changes may be made within the scope of the appended claims and their equivalents without departing from the spirit and scope of the disclosure.

What is claimed is:

1. A computational storage device, comprising:
a memory array configured to store a corpus, the corpus comprising a plurality of subsets, and the plurality of subsets comprising a first subset and a second subset; and
a hardware accelerator configured to:
obtain a language model;
read the plurality of subsets from the memory array;
generate, based on the plurality of subsets, a tokenizer of the language model, and an embedding layer of the language model, a plurality of embedding vectors, the plurality of embedding vectors comprising a first embedding vector and a second embedding vector;
write the plurality of embedding vectors in the memory array;
read, from the memory array, at least one embedding vector associated with a user query from the plurality of embedding vectors; and
perform an inference operation that outputs a response associated with the user query, based on the user query, the at least one embedding vector, and the language model.

2. The computational storage device of claim 1, further comprising:
a memory controller,
wherein the memory array comprises:
a first area accessed by the memory controller; and
a second area different accessed by the hardware accelerator,
wherein the second area is different from the first area, and
wherein the memory controller is limited to access the second area.

3. The computational storage device of claim 2, wherein the memory controller is further configured to write the plurality of subsets in the first area, and
wherein the hardware accelerator is further configured to write the plurality of embedding vectors in the second area.

4. The computational storage device of claim 2, wherein the hardware accelerator is further configured to:
write parameters of the language model in the second area;
obtain the language model by reading the parameters from the second area; and
output a response corresponding to the user query, based on the parameters, the user query, and the at least one embedding vector.

5. The computational storage device of claim 1, wherein the hardware accelerator is further configured to:
receive at least one identifier associated with at least one third embedding vector, the at least one third embedding vector being generated from at least one subset related to the user query, the at least one subset being from the plurality of subsets; and
based on receiving the at least one identifier, read the at least one third embedding vector.

6. The computational storage device of claim 1, wherein the language model comprises:
the tokenizer configured to tokenize an input text and output the tokenized text;
the embedding layer configured to output an embedding vector based on the tokenized text;
a plurality of decoder layers configured to receive the embedding vector, and with each of the plurality of decoder layers further configured to:
receive and process an output of a previous layer, and
transmit the output to a next layer; and
a multi-layer perceptron (MLP) layer configured to receive an output of a final decoder layer among the plurality of decoder layers and output a response corresponding to the tokenized text.

7. The computational storage device of claim 6, wherein the hardware accelerator is further configured to:
tokenize the first subset based on the tokenizer; and
generate the first embedding vector based on the tokenized first subset and the embedding layer.

8. The computational storage device of claim 6, wherein the hardware accelerator is further configured to:
tokenize the user query based on the tokenizer; and
generate an embedding vector based on the tokenized user query and the embedding layer.

9. The computational storage device of claim 8, wherein the at least one embedding vector associated with the user query comprises the first embedding vector, and
wherein the hardware accelerator is further configured to:
input the first embedding vector and the embedding vector based on the tokenized user query into a decoder layer from the plurality of decoder layers;
output a start token of the response associated with the user query, based on the first embedding vector and the embedding vector based on the tokenized user query, using the plurality of decoder layers and the MLP layer; and
input the start token into the embedding layer.

10. The computational storage device of claim 6, wherein the hardware accelerator is further configured to:
generate a first token based on the MLP layer and output the first token into the embedding layer;
generate, based on inputting the first token into the embedding layer, a second token that is a token subsequent to the first token, using the plurality of decoder layers and the MLP layer;
input the second token into the embedding layer; and
generate, based on inputting the second token into the embedding layer, a third token that is a token subsequent to the second token, using the plurality of decoder layers and the MLP layer.

11. The computational storage device of claim 1, wherein the at least one embedding vector associated with the user query comprises the first embedding vector and the second embedding vector,
wherein the inference operation comprises:
a first inference operation that outputs a first response associated with the user query based on the user query and the first embedding vector; and
a second inference operation that outputs a second response associated with the user query based on the user query and the second embedding vector, and
wherein the hardware accelerator is further configured to perform at least part of the first inference operation and at least part of the second inference operation in parallel.

12. The computational storage device of claim 1, wherein each of the plurality of subsets comprises at least one or more paragraphs.

13. A computational storage system, comprising:
a host processor and a host device, the host device comprising a host memory connected to the host processor; and
a computational storage device configured to communicate with the host processor and generate an output,
wherein the computational storage system comprises:
a memory array configured to store a corpus, the corpus comprising a plurality of subsets, the plurality of subsets comprising a first subset and a second subset; and
a hardware accelerator configured to:
obtain a language model;
read the plurality of subsets from the memory array;
generate, based on the plurality of subsets, a tokenizer of the language model, and an embedding layer of the language model, a plurality of embedding vectors, the plurality of embedding vectors comprising a first embedding vector and a second embedding vector;
write the plurality of embedding vectors in the memory array;
read, from the memory array, at least one embedding vector associated with a user query from the plurality of embedding vectors; and
perform an inference operation that outputs a response associated with the user query, based on the user query, the at least one embedding vector, and the language model.

14. The computational storage system of claim 13, wherein the host process is configured to:
obtain at least one address of at least one subset associated with the user query from the corpus;
obtain an identifier associated with the at least one embedding vector, the at least one embedding vector being associated with the at least one address of the at least one subset; and
transmit the identifier of the at least one embedding vector to the computational storage system, and
wherein the hardware accelerator is further configured to read the at least one embedding vector from the memory array based on the identifier of the at least one embedding vector.

15. The computational storage system of claim 14, wherein the hardware accelerator is further configured to:
transmit to the host device, in response to a termination of generation of the plurality of embedding vectors, a relationship table indicating a relationship between a plurality of identifiers associated with the plurality of embedding vectors and a plurality of addresses of the plurality of subsets, and
wherein the host device is further configured to:
receive the relationship table from the hardware accelerator; and
obtain, based on the relationship table, the identifier of the at least one embedding vector associated with the address of the at least one subset.

16. The computational storage system of claim 14, wherein the hardware accelerator is further configured to:
based on the at least one embedding vector, the user query, and the language model, output at least one response corresponding to the user query and an evaluation metric corresponding to the at least one response; and
transmit the at least one response and the evaluation metric to the host device, and
wherein the host device is further configured to:
determine a response with a highest evaluation metric from the at least one response as a final response; and
output the final response to a device external to the host device.

17. The computational storage system of claim 14, wherein the hardware accelerator is further configured to:
output at least one first token and a first evaluation metric for each of the at least one first token based on the at least one embedding vector, the user query, and the language model, ;
transmit, to the host processor, the at least one first token and the first evaluation metric for each of the at least one first token; and
output at least one second token and a second evaluation metric for each of the at least one second token based on a highest first token and the language model,
wherein the host processor is further configured to:
select the highest first token having a highest first evaluation metric from the at least one first token;
transmit the highest first token with the highest first evaluation metric to the hardware accelerator;
determine a second token with a second highest evaluation metric as a text token, the second token being from of the first token with the highest first evaluation metric, and
wherein a response to the user query comprises the first token and the second token.

18. The computational storage system of claim 14, wherein the hardware accelerator and the memory array are configured to communicate with each other based on a first protocol,
wherein the computational storage device is configured to communicate with the host device based on a second protocol different from the first protocol, and
wherein an average communication speed based on the first protocol is greater than an average communication speed based on the second protocol.

19. The computational storage system of claim 18, wherein the first protocol is an Advanced eXtensible Interface (AXI) protocol, and
wherein the second protocol is a Peripheral Component Interconnect (PCI)-express protocol.

20. A computational storage system, comprising:
a host device comprising a host processor and a host memory that is connected to the host processor; and
a computational storage device, the computational storage device being configured to communicate with the host processor and to generate an output,
wherein the computational storage device comprises:
a memory array configured to store a corpus, the corpus comprising a plurality of subsets; and
a hardware accelerator configured to:
obtain a language model,
read the plurality of subsets from the memory array,
generate a plurality of embedding vectors based on the plurality of subsets, a tokenizer of the language model, and an embedding layer of the language model, and
write the plurality of generated embedding vectors in the memory array,
wherein the host processor is configured to:
index, from the corpus, at least one embedding vector associated with a user query; and
transmit, to the computational storage device, at least one identifier associated with the at least one embedding vector,
wherein the hardware accelerator is further configured to:
read the at least one embedding vector from the memory array based on the at least one identifier of the at least one embedding vector; and
perform an inference operation that outputs a response corresponding to the user query based on the user query, the at least one embedding vector, and the language model,
wherein the hardware accelerator and the memory array are configured to communicate with each other based on a first protocol,
wherein the computational storage device is configured to communicate with the host device based on a second protocol different from the first protocol, and
wherein an average communication speed according to the first protocol is greater than an average communication speed according to the second protocol.
